(19) United States
(12) Patent Application Publication
(10) Pub. No.: US 2007/0165405 A1
(43) Pub. Date: Jul. 19, 2007

(54) Water-resistant illumination apparatus

(76) Inventor: Chuen-Shing Chen, Taichung Hsien (TW)

Correspondence Address: NIXON & VANDERHYE, PC, 901 NORTH GLEBE ROAD, 11TH FLOOR, ARLINGTON, VA, 22203, US

(21) Appl. No.: 11/334,541

(22) Filed: Jan. 19, 2006

(51) Int. Cl. F21V 33/00

(52) U.S. Cl. 362/253

(57) ABSTRACT

A water-resistant illumination apparatus includes a lighting device disposed in a transparent barrel and between a positioning seat and a positioning sleeve that are mounted in the barrel and that are disposed respectively adjacent to opposite first and second open ends of the barrel. The lighting device includes a circuit board mounted on a mounting seat that abuts against the positioning seat and the positioning sleeve, condensing members that are disposed respectively around LEDs, and a driving unit disposed in the barrel for activating the LEDs. A first seal washer is disposed among and abuts against the barrel, the positioning seat, and a first cap pressed-fitted within the first open end of the barrel. A second seal washer is disposed among and abuts against the barrel, the positioning sleeve, and a second cap pressed-fitted with in the second open end of the barrel.

### BACKGROUND OF THE INVENTION

1. Field of the Invention

The invention relates to an illumination apparatus, more particularly to a water-resistant illumination apparatus for machining equipment, such as lathes.

2. Description of the Related Art

A conventional water-resistant illumination apparatus for machining equipment includes a fluorescent lamp. However, the fluorescent lamp has a service life of only about 6000 hours, and light generated by the fluorescent lamp is not effectively condensed.

### SUMMARY OF THE INVENTION

Therefore, the object of the present invention is to provide a water-resistant illumination apparatus that has a superior heat dissipating capability and a longer service life and that can achieve high-brightness illumination.

According to the present invention, an illumination apparatus comprises:

a transparent barrel having opposite first and second open ends;

a tubular positioning seat mounted in the barrel and disposed adjacent to the first open end of the barrel, the positioning seat having an outer diameter slightly smaller than an inner diameter of the barrel;

a positioning sleeve mounted in the barrel and disposed adjacent to the second open end of the barrel, the positioning sleeve having an outer diameter slightly smaller than the inner diameter of the barrel;

a lighting device disposed in the barrel and between the positioning seat and the positioning sleeve, the lighting device including

a mounting seat positioned between and abutting against the positioning seat and the positioning sleeve,

a circuit board mounted on the mounting seat,

a plurality of lighting units, each of which has a light emitting diode mounted on and above the circuit board, and a condensing member mounted on the circuit board and disposed around the light emitting diode, and

a driving unit disposed in the barrel, connected electrically to the circuit board, and adapted to be coupled electrically to an external power source for activating the light emitting diodes of the lighting units;

a first cap press-fitted within the first open end of the barrel and abutting against the positioning seat;

a second cap press-fitted within the second open end of the barrel and abutting against the positioning sleeve, the second cap being formed with a central opening;

a first seal washer disposed among and abutting against the barrel, the positioning seat and the first cap so as to establish a liquid-tight seal thereamong;

a second seal washer disposed among and abutting against the barrel, the positioning sleeve and the second cap so as to establish a liquid-tight seal thereamong; and

a water-resistant plug extending through the opening in the second cap and plugged sealingly into the positioning sleeve.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded perspective view showing the first preferred embodiment of an illumination apparatus according to the present invention;

FIG. 2 is a fragmentary schematic sectional view of the first preferred embodiment taken along an axial direction of a barrel;

FIG. 3 is a schematic sectional view of the first preferred embodiment taken along a vertical direction;

FIG. 4 is a schematic view of the first preferred embodiment;

FIG. 5 is a perspective view showing the second preferred embodiment of an illumination apparatus according to the present invention; and

FIG. 6 is a schematic sectional view of the second preferred embodiment.

### DETAILED DESCRIPTION OF THE PREFERRED EMBODIMENTS

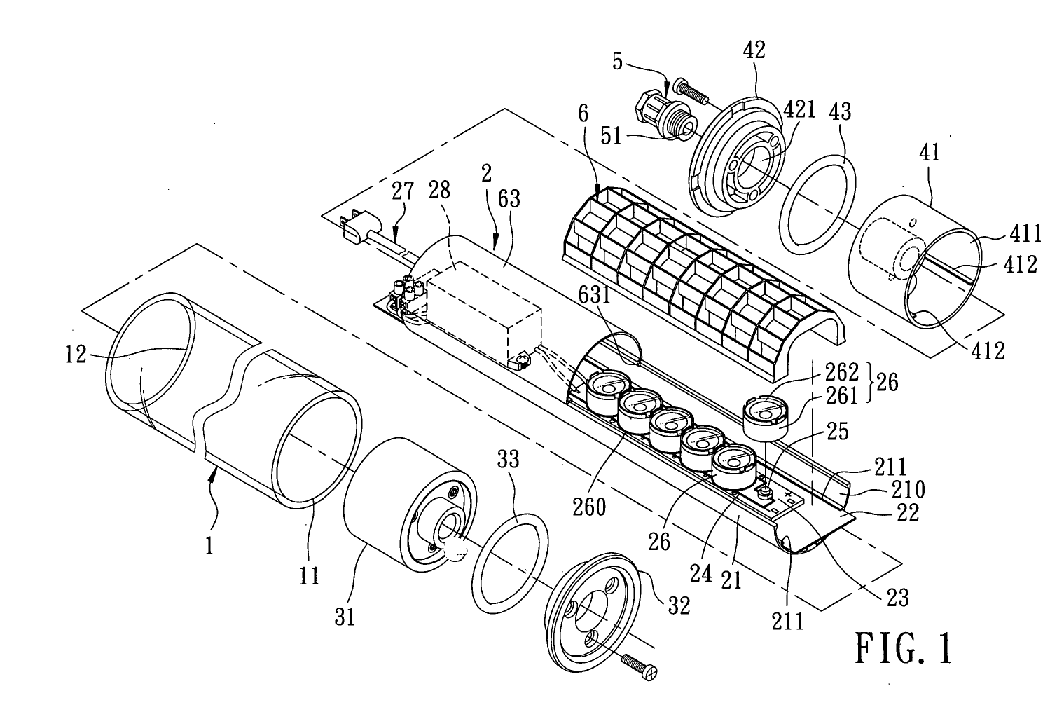

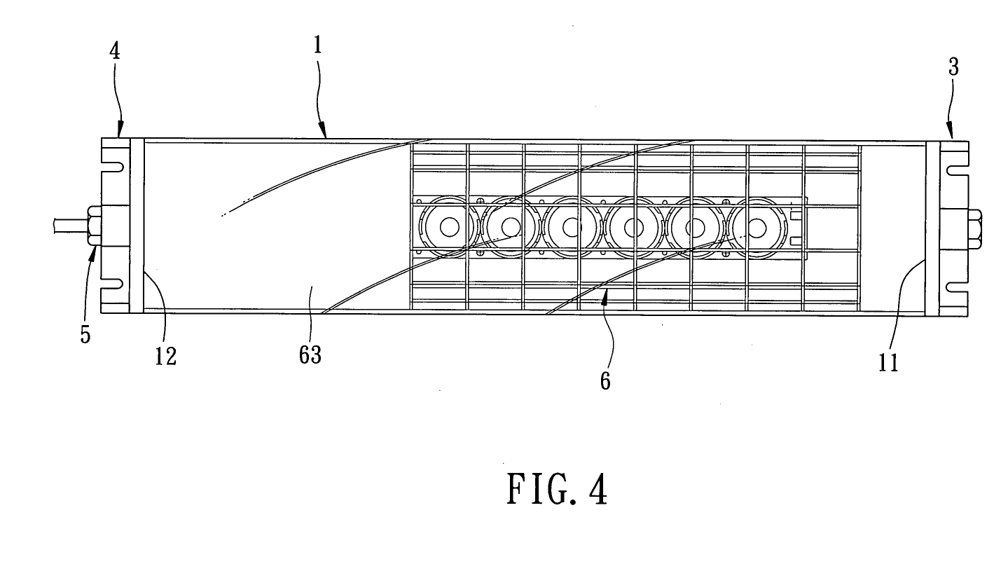

Referring to FIGS. 1, 2 and 4, the first preferred embodiment of an illumination apparatus according to the present invention is shown to include a transparent barrel 1, a tubular positioning seat 31, a positioning sleeve 41, a lighting device 2, a first cap 32, a second cap 42, a first seal washer 33, a second seal washer 43, and a water-resistant plug 5.

The transparent barrel 1 has opposite first and second open ends 11, 12.

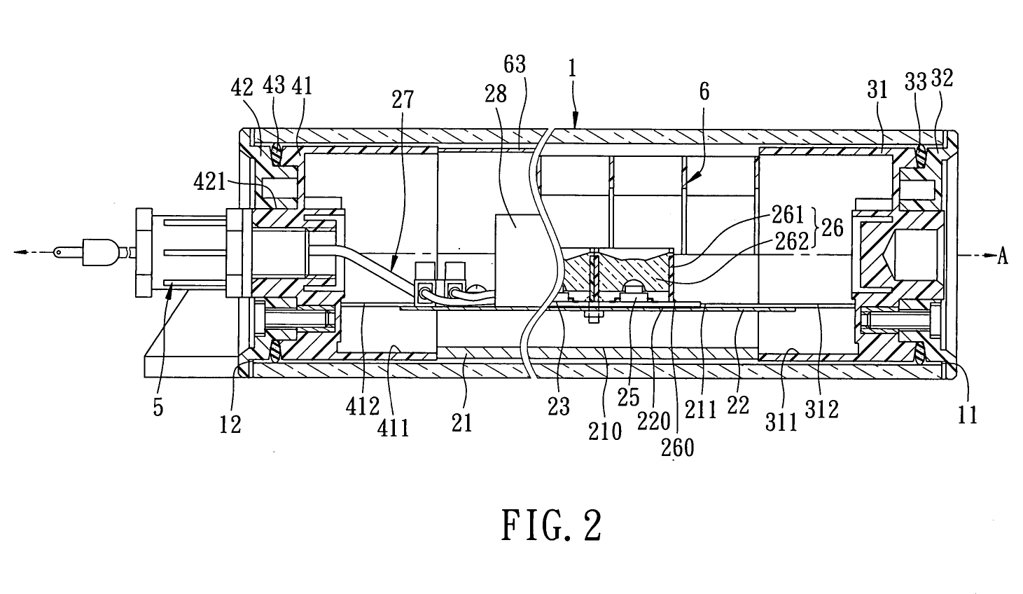

The tubular positioning seat 31 is mounted in the barrel 1, and is disposed adjacent to the first open end 11 of the barrel 1. The positioning seat 31 has an outer diameter slightly smaller than an inner diameter of the barrel 1. In this embodiment, the positioning seat 31 has an inner wall surface 311, and a pair of engaging flanges 312 (only one is visible in FIG. 2) extending toward each other.

The positioning sleeve 41 is mounted in the barrel 1, and is disposed adjacent to the second open end 12 of the barrel 1. The positioning sleeve 41 has an outer diameter slightly smaller than the inner diameter of the barrel 1. In this embodiment, similar to the positioning seat 31, the positioning sleeve 41 has an inner wall surface 411, and a pair of engaging flanges 412 extending toward each other, as best shown in FIG. 1.

The lighting device 2 is disposed in the barrel 1 and between the positioning seat 31 and the positioning sleeve 41. The lighting device 2 includes a mounting seat 21, a circuit board 23, a plurality of lighting units, and a driving unit 28.

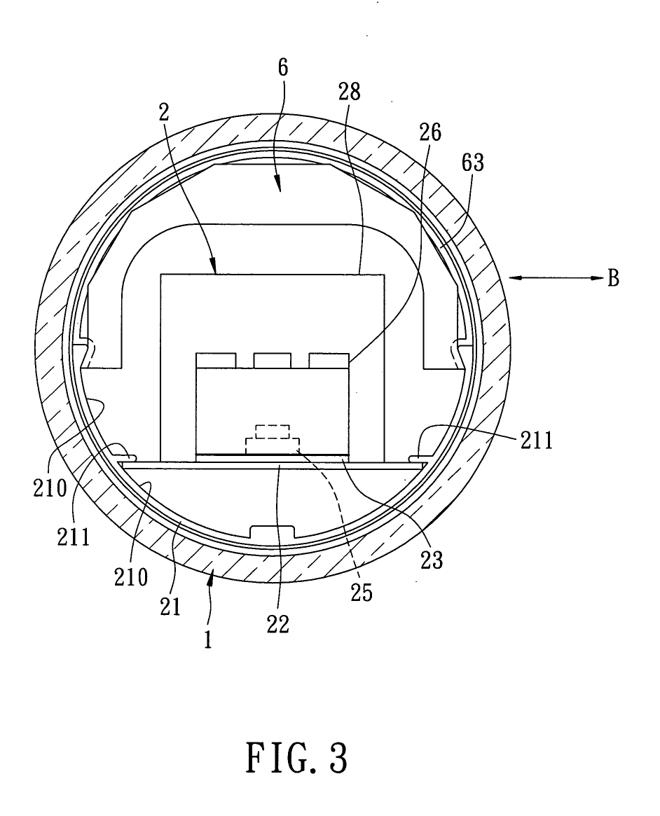

The mounting seat 21 is positioned between and abuts against the positioning seat 31 and the positioning sleeve 41. In this embodiment, the mounting seat 21 is made of aluminum, and is in the form of a curved elongate plate extending along an axial direction (A) of the barrel 1. The mounting seat 21 has an inner surface 210, and a pair of engaging flanges 211 extending from the inner surface 210 toward each other in a direction (B) perpendicular to the axial direction (A), as best shown in FIG. 3.

In this embodiment, the lighting device 2 further includes a heat dissipating plate 22 mounted on the mounting seat 21 and positioned between the positioning seat 31 and the positioning sleeve 41. The heat dissipating plate 22 is positioned movably below the engaging flanges 211 of the mounting seat 21, the engaging flanges 312 of the positioning seat 31 and the engaging flanges 412 of the positioning sleeve 41, as shown in FIG. 2.

In this embodiment, the circuit board 23 is mounted on the heat dissipating plate 22 by heat-resistant glue 220 so as to be in thermal contact therewith.

Each of the lighting units has a light emitting diode 25 mounted on the circuit board 23, and a condensing member 26 mounted on and above the circuit board 23 and disposed around the light emitting diode 25. In this embodiment, for each lighting unit, the condensing member 26 has a hollow lens-mounting seat 261 disposed fixedly around the light emitting diode 25 by heat-resistant glue 260, and a condensing lens 262 mounted on the lens-mounting seat 261 and cooperating with the lens-mounting seat 261 so as to cover the light emitting diode 25 for condensing light generated thereby.

The driving unit 28 is disposed in the barrel 1, is connected electrically to the circuit board 23, and is adapted to be coupled electrically to an external power source (not shown) by means of a power cord 27 for activating the light emitting diodes 25 of the lighting units in a known manner. In this embodiment, the driving unit 28 is mounted on and is in thermal contact with the heat dissipating plate 22.

The first cap 32 is press-fitted within the first open end 11 of the barrel 1, and abuts against and is connected to the positioning seat 31 by screw fasteners (only one is shown), as shown in FIG. 2.

The second cap 42 is press-fitted within the second open end 12 of the barrel 1, and abuts against and is connected to the positioning sleeve 41 by screw fasteners (only one is shown) , as shown in FIG. 2. The second cap 42 is formed with a central opening 421.

The first seal washer 33 is disposed among and abuts against the barrel 1, the positioning seat 31 and the first cap 32 so as establish a liquid-tight seal thereamong, as shown in FIG. 2.

The second seal washer 43 is disposed among and abuts against the barrel 1, the positioning sleeve 41 and the second cap 42 so as establish a liquid-tight seal thereamong, as shown in FIG. 2.

The water-resistant plug 5 extends through the opening 421 in the second cap 42, and is plugged sealingly into the positioning sleeve 41. The water-resistant plug 5 has a through hole 51 that permits extension of the power cord 27 therethrough.

In this embodiment, a curved cover 63 is mounted on the mounting seat 21, and is disposed above the driving unit 28. A U-shaped grating seat 6 is mounted on the mounting seat 21, and is disposed above the lighting units.

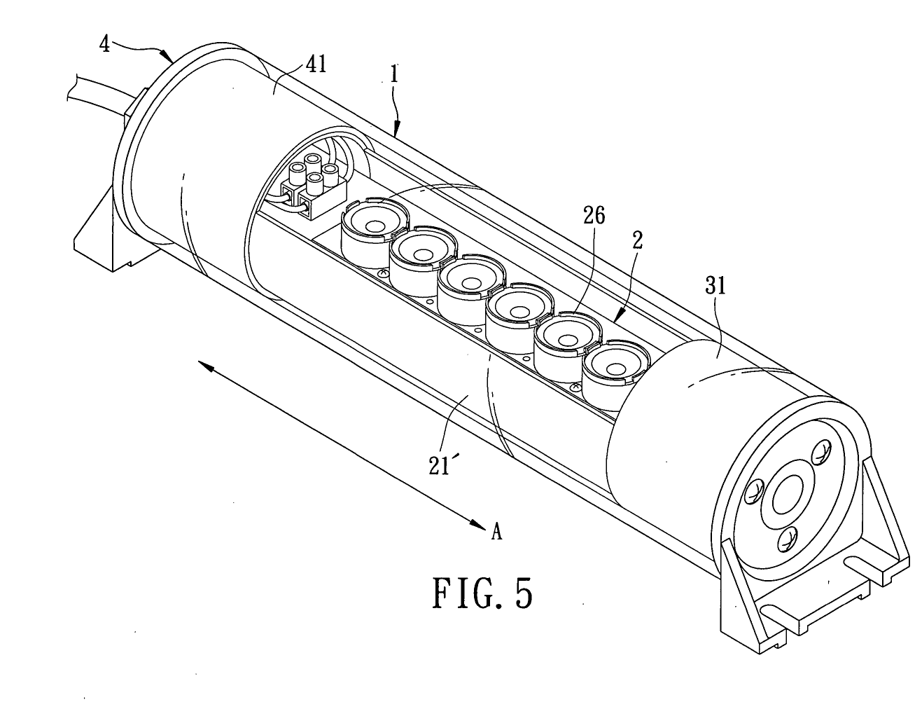

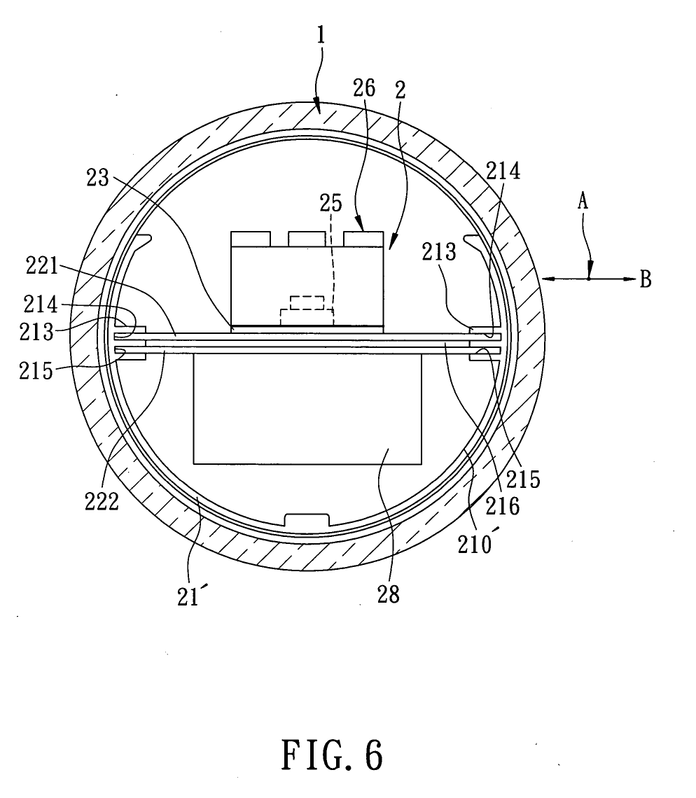

FIGS. 5 and 6 illustrate the second preferred embodiment of an illumination apparatus according to this invention, which is a modification of the first preferred embodiment. In this embodiment, as shown in FIG. 6, the mounting seat 21′ is in the form of a curved elongate plate extending along an axial direction (A) of the barrel 1. The mounting seat 21′ has an inner surface 210′, and a pair of positioning blocks 213 extending from the inner surface 210′ toward each other in a direction (B) perpendicular to the axial direction. Each positioning block 213 is formed with an upper positioning groove 214 extending along the axial direction (A), and a lower positioning groove 215 disposed below and parallel to the upper positioning groove 214.

As shown in FIG. 6, the lighting device 2′ further includes first and second heat dissipating plates 221, 222 mounted on the mounting seat 21′ and positioned between the positioning seat 31 and the positioning sleeve 41. The first heat dissipating plate 221 is disposed above the second heat dissipating plate 222, is received movably within the upper positioning grooves 214 in the positioning blocks 213 of the mounting seat 21′, and is in thermal contact with the circuit board 23. The second heat dissipating plate 222 is received movably within the lower positioning grooves 215 in the positioning blocks 213 of the mounting seat 21′, and is in thermal contact with the driving unit 28.

The following are some of the advantages attributed to the illumination apparatus of the present invention:

1. Due to the presence of the heat dissipating plate 22 and the first and second heat dissipating plates 221, 222, heat generated by the driving unit 28 and the light emitting diodes 25 can be dissipated.

2. Due to the use of the light emitting diodes 25 having a service life of about 100,000 hours, the illumination apparatus of this invention has a longer service life as compared to the aforesaid conventional illumination apparatus.

3. Due to the presence of the condensing lenses 262 and the grating seat 6, the illumination apparatus can achieve high-brightness illumination.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An illumination apparatus comprising:
a transparent barrel having opposite first and second open ends;
a tubular positioning seat mounted in said barrel and disposed adjacent to said first open end of said barrel, said positioning seat having an outer diameter slightly smaller than an inner diameter of said barrel;
a positioning sleeve mounted in said barrel and disposed adjacent to said second open end of said barrel, said positioning sleeve having an outer diameter slightly smaller than the inner diameter of said barrel;
a lighting device disposed in said barrel and between said positioning seat and said positioning sleeve, said lighting device including
a mounting seat positioned between and abutting against said positioning seat and said positioning sleeve,
a circuit board mounted on said mounting seat,
a plurality of lighting units, each of which has a light emitting diode mounted on and above said circuit board, and a condensing member mounted on said circuit board and disposed around said light emitting diode, and
a driving unit disposed in said barrel, connected electrically to said circuit board, and adapted to be coupled electrically to an external power source for activating said light emitting diodes of said lighting units;
a first cap press-fitted within said first open end of said barrel and abutting against said positioning seat;
a second cap press-fitted within said second open end of said barrel and abutting against said positioning sleeve, said second cap being formed with a central opening;
a first seal washer disposed among and abutting against said barrel, said positioning seat and said first cap so as to establish a liquid-tight seal thereamong;
a second seal washer disposed among and abutting against said barrel, said positioning sleeve and said second cap so as to establish a liquid-tight seal thereamong; and
a water-resistant plug extending through said opening in said second cap and plugged sealingly into said positioning sleeve.

2. The illumination apparatus as claimed in claim 1, wherein said lighting device further includes a heat dissipating plate mounted on said mounting seat and positioned between said positioning seat and said positioning sleeve, said circuit board and said driving unit being mounted on and being in thermal contact with said heat dissipating plate.

3. The illumination apparatus as claimed in claim 2, wherein said mounting seat is in the form of a curved elongate plate extending along an axial direction of said barrel, said mounting seat having an inner surface, and a pair of engaging flanges extending from said inner surface toward each other in a direction perpendicular to the axial direction, said heat dissipating plate being disposed movably below said engaging flanges.

4. The illumination apparatus as claimed in claim 1, wherein said lighting device further includes first and second heat dissipating plates mounted on said mounting seat and positioned between said positioning seat and said positioning sleeve, said first heat dissipating plate being disposed above said second heat dissipating plate and being in thermal contact with said circuit board, said second heat dissipating plate being in thermal contact with said driving unit.

5. The illumination apparatus as claimed in claim 4, wherein said mounting seat is in the form of a curved elongate plate extending along an axial direction of said barrel, said mounting seat having an inner surface, and a pair of positioning blocks extending from said inner surface of said mounting seat toward each other in a direction perpendicular to the axial direction, each of said positioning blocks being formed with an upper positioning groove extending along the axial direction, and a lower positioning groove disposed below and parallel to said upper positioning groove, said first heat dissipating plate being received movably within said upper positioning grooves in said positioning blocks of said mounting seat, said second heat dissipating plate being received movably within said lower positioning grooves in said positioning blocks of said mounting seat.

6. The illumination apparatus as claimed in claim 1, wherein said condensing member of each of said lighting units of said lighting device has a hollow lens-mounting seat disposed fixedly around said light emitting diode of a corresponding one of said lighting units of said lighting device, and a condensing lens mounted on said lens-mounting seat and cooperating with said lens-mounting seat so as to cover said light emitting diode of the corresponding one of said lighting units of said lighting device for condensing light generated thereby.
